(19) United States
(12) Patent Application Publication
(10) Pub. No.: US 2013/0115338 A1
(43) Pub. Date: May 9, 2013

(54) CONSUMABLES AND METHODS OF PRODUCTION THEREOF

(71) Applicants: Peter Clarke, Berkshire (GB); Clive Richard Thomas Norton, Chatham, NJ (US); Sarah Marshall, West Berkshire (GB); Simon Bradbury, Middlesex (GB)

(72) Inventors: Peter Clarke, Berkshire (GB); Clive Richard Thomas Norton, Chatham, NJ (US); Sarah Marshall, West Berkshire (GB); Simon Bradbury, Middlesex (GB)

(21) Appl. No.: 13/583,342

(22) PCT Filed: Mar. 23, 2011
(86) PCT No.: PCT/GB2011/050589

§ 371 Date: Nov. 16, 2012

Related U.S. Application Data
(60) Provisional application No. 61/316,455, filed on Mar. 23, 2010.

(30) Foreign Application Priority Data
Mar. 23, 2010 (GB) 1004894.0

(51) Int. Cl. A23G 3/34

(52) U.S. Cl. CPC A23G 3/0068
USPC 426/103; 426/89; 426/516; 426/282

(57) ABSTRACT

The present invention relates to a consumable product comprising an extruded body portion, the body portion being formed with a plurality of capillaries disposed therein, wherein the capillaries have a non-uniform cross section along their length. The present invention also provides a method of producing the same.

### TECHNICAL FIELD OF THE INVENTION

The present invention relates to consumable products and also to a method of production thereof. In particular, the invention relates to consumable products comprising at least one capillary, wherein the capillary may be filled with a substance.

### BACKGROUND TO THE INVENTION

It is desirable to produce consumable products (i.e. edible items such as foodstuffs, toothpaste, etc) formed of different components, so as to increase sensory pleasure. A number of consumable products exist, which have a flavoured liquid or syrup centre which is released upon chewing. For example, WO 2007/056685 discloses an apparatus and method for the continuous production of centre-filled confectionery products in the format of a continuous extrudate having a plurality of centre-filled confectionery ropes. Whilst a product formed from such an apparatus does increase sensory pleasure, the period of pleasure is often short lived as the centre is released quickly and/or degraded. It is desirable to provide a consumable product which can release a capillary centre over an extended period of time.

There is also a demand for providing consumable products having a reduced fat or sugar content. It is thus desirable to provide a consumable product which can be produced having a lowered fat or sugar content, whilst still maintaining an excellent sensory pleasure.

Further, there is demand for consumable products having improved visual appearance whilst maintaining flavour. It is also desirable to provide a consumable product which is eye-catching whilst still providing a desirable flavour.

Yet further there is demand for consumable products having improved convenience whilst maintaining or improving flavour. It is thus desirable to provide a consumable product which increases convenience whilst still maintaining, or even improving, flavour.

It is desirable to provide a consumable product having an improved or novel sensory experience.

It is also desirable to provide a consumable product which may have a liquid filling, whereby the leakage of the liquid filling from the ends of the product is mitigated or greatly reduced.

### SUMMARY OF THE INVENTION

According to a first aspect of the present invention, there is provided a consumable product comprising an extruded body portion, the body portion being formed with a plurality of capillaries disposed therein, wherein the capillaries have a non-uniform cross section along their length.

According to another aspect of the present invention there is provided a process for manufacturing a consumable product comprising a body portion having a plurality of capillaries disposed therein, the process comprising the step of extruding a material with a plurality of capillaries disposed therein, wherein the capillaries have a non-uniform cross section along their length. A yet further aspect of the invention provides an apparatus adapted for producing a consumable product according to this process.

By the term “non-uniform” cross section, it is meant that the cross-sectional shape or area (size) of the capillaries does not remain constant along their length, and may be increased, decreased or altered as required in either direction along the length of the consumable product.

It should be understood that the term “capillary” generally refers to a conduit or space created by an extrusion or other forming process within the body of the product. The capillary typically contains matter, and that matter can be in the form of a gas, a liquid, a solid, or a mixture thereof

The capillaries can have the same or different shapes. Some or all capillaries can be ‘cone-shaped’, wherein the capillaries increase or decrease in diameter depending upon which end of the product the capillary is viewed from. Alternatively, the capillaries may have an ‘oscillating’ shape, such that they have alternating sections having narrower diameters followed by sections having wider diameters. This is discussed further hereinbelow.

The consumable product of the present invention therefore provides for an extended release of any material inserted into the capillaries, and/or a large voidage formed by the capillaries so as to reduce the amount of material used in the body portion of the product, whilst maintaining the overall size of the product. Further the consumable product has a more diverse cross section such that it is more eye catching, and with the convenience of any material inserted into the capillaries being integral with the consumable product and leakage from the ends of the product minimised where end sections of the body portion do not contain capillaries and/or where the end sections of the body portion comprise capillaries having a relatively small cross-section so as to minimise capillary action.

It should be understood that the term “liquid” is intended to mean that the material is capable of or has a readiness to flow, including gels, pastes and plasticized chocolate. Furthermore, this term is intended to include (but is not limited to) those materials which may be “molten” during extrusion. The skilled addressee will understand that the term “molten” means that the material has been reduced to a liquid form or a form which exhibits the properties of a liquid.

The body portion may be at least partially or substantially solid, so that it can no longer be considered to flow in a liquid form.

The material used to produce the body portion may comprise a number of materials commonly used in the production of consumable products—for example foodstuffs such as confectionery (e.g. candy, gum and chocolate etc.), meat, cereal, cheese, potato, pastry, jelly, custard, fruit, ice cream, spreads or pate, or indeed consumable products such as pet food or toothpaste.

In some embodiments, the body portion comprises a confectionery material, for example chocolate. Suitable chocolate includes dark, milk, white and compound chocolate. In some embodiments, the confectionery comprises a chewing gum, bubble gum or gum base material (or constituents thereof). In other embodiments, the confectionery comprises a candy material. Suitable candy includes hard candy, chewy candy, gummy candy, jelly candy, toffee, fudge, nougat and the like.

The capillaries may extend along substantially the entire length of the body portion, but may in some embodiments extend no less than 75%, 80%, 90%, 95% or 99% along the length of the body portion (for example, when it is desired to seal the ends of the body portion). If the capillaries extend along the entire length of body portion, typically the ends of the capillaries are visible at one or more ends of the body portion.

One or more of the capillaries may be filled with a material which is different from that of the material used to form the body portion. Different capillaries may incorporate different materials if desired, and/or any one capillary can be filled with different substances along its length. The capillaries may be filled with a fluid material. Such a fluid may comprise a liquid. The capillaries may be filled with a material which is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e,g. a solution of sugars and gelatin will eventually set over time).

The capillaries need not be filled with a fill material and may simply form a void filled with an air or inert gas. Thus a consumable product may be formed having a large exterior dimensions, but a substantially reduced density which provides good sensory properties.

If the capillaries are filled, suitable filling materials for the capillaries include, but are not limited to, aqueous media, fats, chocolate, caramel, cocoa butter, fondant, syrups, peanut butter, jam, jelly, gels, truffle, praline, chewy candy, hard candy, fruit or vegetable purees, medications, sauces such as ketchup, custard, cream, or any combination or mixture thereof.

If desired, the product may further comprise a coating portion to envelop or enrobe the body portion. The skilled addressee will appreciate that a number of coatings could be employed—for example chocolate, gum, candy and sugar etc.

The body portion may be connected to one or more further portions. In some embodiments, the body portion is sandwiched between materials or may be connected or laminated to one or more layers. The further portion or portions may or may not contain inclusions. Suitable inclusions will be apparent to the skilled addressee and include a wide range of granular or powdered material, liquid-filled beads and encapsulated materials etc.

In some embodiments, multiple capillaries may be distributed substantially uniformly throughout the body portion, and may be spaced evenly apart from adjacent capillaries. In other embodiments, capillaries may be distributed in pre-defined configurations within the body portion, such as around the periphery of the body portion, or in groups at one or more locations within the body. In some embodiments the body portion has a circular, elliptical, regular polygonal or semi-circular cross-section. The body portion may be shaped in the form of a cylinder, a rope, a filament, a strip, a ribbon or the like, or may be shaped in the form of a standard consumable product such a chocolate bar, or chewing gum slab, pellet, ball, stick or ribbon, for example. The exterior of the body portion may be irregular or regular in shape. Furthermore, the body portion may be formed in potentially any shape, for example in the shape of an object, cartoon character or an animal to name a few.

The capillaries of the invention have a non-uniform cross section along their length. Suitable examples of such non-uniform cross section include variations in shape and/or area along the capillary length. For instance, a capillary could exhibit a maximum cross-sectional area that is at least 10% greater than the minimum cross-sectional area of that capillary, typically at least 20% greater, more typically at least 50% greater, most typically at least 95% greater.

By way of example of variation of cross-sectional area with length, the capillary may be roughly circular in cross section, with a diameter that oscillates from a small to a large diameter along the length of the capillary. In the limit, the arrangement would give rise to discrete ‘bubbles’ being present laterally along the length of the consumable product, wherein the ‘bubbles’ are separated by areas formed of the same material as the body portion and/or capillaries having a negligible or no cross-sectional area. The oscillations can be sinusoidal or regularly spaced in any manner, such that all ‘bubbles’ are of equal size, or irregular such that differently sized ‘bubbles’ are created. The ‘bubbles’ can also have non-circular cross sections, such as triangles, squares, ovals, stars, and the like.

It is this variation in cross-sectional diameter such that at least a portion of at least one capillary has a somewhat narrower diameter which helps prevent leakage of the centre-fill from the capillary. If the capillary is of a substantially consistent and wide diameter, there may be issues of premature leakage of the centre-fill both when a consumer bites into the product and also when the product has been extruded and is then being cut to create the discrete product items. However, if at least part of the diameter of at least one capillary is narrower than the rest, there is significantly reduced scope for the leakage to occur. Indeed, in the embodiments of the invention comprising the ‘bubbles’ capillaries, or where the narrow part of the capillaries are on a micrometre scale, the arrangement of the capillaries and the cutting process can be set up such that the extruded product is cut precisely in the sections of the product where the at least one capillary is at it narrowest, thus removing the premature leakage problem.

By way of example of variation of shape with length, the cross section of the capillary can oscillate, along the length of the capillary, between a shape which is oriented vertically and the same shape which is oriented horizontally. Other suitable shapes include rectangles, ovals, stars, etc.

Variations in cross-sectional area with respect to length can be achieved by varying the rate of extrusion of the body portion in relation to the rate of capillary formation. For example, if the rate of extrusion of the body portion is slowed, but the rate of capillary formation (by virtue of pumping gas or liquid into the extrudate via a die) is maintained or sped up, then a bigger capillary cross section will result. Conversely if the rate of extrusion of the body portion is sped up (or maintained), and the rate of capillary formation is maintained (or slowed), then a smaller capillary cross section will result.

Further variations in cross-sectional area with respect to length can be achieved by extruding the body portion onto a convenor belt and varying the speed of extrusion relative to the speed of the belt or visa versa.

A range of effects can be formed in the extrudate by rotating the die head whilst extruding onto a planar convenor belt, or rotating the extrudate after extrusion from a static die head, so as to produce capillaries in the format of swirls or helices.

In order to create ‘bubbles’ by the methodology described above, the rate of capillary formation needs to be virtually or completely stopped for a time period. Capillary formation could be stopped by extruding the body portion and preventing the flow of the centre-fill material. An alternative method of fowling ‘bubbles’ is to rotate the body portion or the die through which the capillary gas/liquid passes, in order to ‘nip’ the capillary. A combination of both methods can of course also be used if desired.

“Bubbles' can also be formed by alternating the materials pumped through a nozzle which forms the capillary in the body potion. For example, the bubbles could be formed by pumping a liquid fill into a nozzle for a short period of time, before a material which is the same as the body portion is extruded through the nozzle—in this way, by alternating between pumping materials through a nozzle, a ‘plug’ can be formed between capillaries of liquid fill.

Variations of shape with length can be obtained by rotating the body portion or the die through which the capillary gas/liquid passes, such that the orientation of the capillary changes with respect to the body portion.

The nozzles of the die may or may not be located centrally in the die head. If it is located centrally in the extrudate, a sinusoidal capillary or line of bubbles can be produced. Alternatively, if the nozzle is not located centrally (i.e. off-centre) in the die head, different capillary profiles can easily be produced and further formats can be produced by rotating the extrudate relative to the die head. For example, a capillary forming a ‘ring, ‘swirl’, ‘loop’, or part helical-shaped pathway through the body portion can be produced if the die is rotated slowly and continuously; or, if the fluid expulsion from the die is sufficiently rapid and/or discrete to ‘nip’ the capillary into bubbles, a pattern of bubbles can be created where the bubbles are alternately located at the top or bottom of the body portion.

The die may be equipped with one or a plurality of injector nozzles as desired.

A further manner of obtaining the non-uniform capillary cross-sectional diameter is by employing the use of a moveable belt on the extruder which is able to tilt in different directions to move the extrudate relative to the injection of fluid from the die while the die remains stationary. The extrudate may be expelled from the extruder onto a conveyor belt and the speed of the belt may be varied so as to move at a faster or slower rate relative to the speed of extrusion.

Any two or more capillaries may have different cross-sectional areas from one another. Such an arrangement will allow, if desired, for different quantities of different fill materials to be incorporated into different capillaries. Furthermore, the two or more capillaries may have different cross-sectional shapes or the same cross-sectional shapes but present in a staggered format. For example, the consumable product may have capillaries having a cross-sectional shapes including stars and triangles, or different shapes of animals etc.

In one embodiment, the capillaries in the body portion result in a voidage in the range of about 1-99% of the extrudate, or in the range of 5-99% of the extrudate. The voidage may be in the range of about 10-60%, 20-50%, 30-45%, or 35-40%. The voidage may also be in inteimediate points in these ranges, for example, about 5-40%, 5-45%, 5-50%, 5-60%, 10-40%, 10-45%, 10-50%, 10-99%, 20-60%, 20-45%, 20-40%, 20-60%, 20-99%, 30-40%, 30-50%, 30-60% or 30-99%. The voidage may be up to about 99%, 95%, 90%, 80%, 60%, 50%, 45%, 35%, 30%, 20%, 10%, or 5%. The voidage may be over about 5%, 10%, 15%, 20%, 25%, 30%, 35%, 40%, 45%, 50%, 55%, 60%, 65%, 70%, 75%, 80%, 85%, 90% or 95%.

It should be understood that the term “voidage” generally refers to the volume percent of the capillary volume relative to the sum of the capillary volume and the extruded body portion volume. That is voidage (%)=100×capillary volume/(capillary volume+extruded body portion volume). In some embodiments, the extruded body portion volume does not include any central region volume created by certain dies, such as an annular die.

The incorporation of capillaries of a small cross-sectional width or diameter enables the capillaries in the body portion to be filled with contrasting or complementary consumable materials whilst avoiding the need to incorporate large centre-fill areas which may be prone to leakage through, or out of, the consumable product. The use of a plurality of capillaries also enables two or more materials to be incorporated into the consumable product to give multiple textures, tastes, colours and/or mouth-feel sensations, throughout the whole consumable product.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of capillaries”, numbers up to 50 and higher are contemplated.

The capillaries may be filled by entrainment processes, or alternatively may be filled by using pump to provide the contrasting or complementary consumable materials.

In some embodiments, the capillaries have a diameter or width of no more than about 2 mm, 1 mm, 0.5 mm, 0.25 mm, or even less. It is possible to have capillaries having a diameter or width of no more than about 100 μm, 50 μm or 10 μm.

The consumable product may comprise a first extruded portion and a second extruded portion, wherein each portion has a plurality of capillaries disposed therein, and the capillaries of the first and second portions are:
a) discontinuous; and/or
b) continuous and oriented in more than one direction.

The capillaries of each portion may be formed substantially parallel to one another. In one embodiment, the first and second portions are in a stacked configuration, such that the capillaries of the first and second portions are substantially parallel to each other. In an alternative embodiment, the first and second portions are in a folded configuration. In yet another alternative embodiment, the first and second portions are discontinuous and the capillaries are oriented in a random configuration in relation to one another. In some embodiments, the capillaries of the first and/or second portions have a diameter or width of no more than about 3 mm, 2 mm, 1 mm, 0.5 mm, 0.25 mm, or less. It is possible to have capillaries having a diameter or width as low as about 100 μm, 50 μm or 10 μm. The capillaries of the first and/or second portions may have different widths or diameters.

There may be further portions in addition to the first and second portions, which may or may not comprise capillaries. In one embodiment, the consumable product comprises the first portion separated from the second portion by one or more further portions that may or may not contain capillaries.

The first and second portions may be as described hereinabove for the body portion. The first and second portions may comprise the same material or different materials. For example, the first portion may be chocolate and the second portion may be candy. The capillaries in each of the first and second portions may be filled with the same or different materials. One or more capillaries in the first and/or second portions may be filled with different material(s) to other capillaries in the first and/or second portion.

According to a further embodiment of the invention, there is provided a consumable product comprising an extruded body portion having a plurality of capillaries disposed therein, wherein each capillary has a non-uniform cross section along its length and is separated from each adjacent capillary by a wall formed from the extruded body portion and wherein the wall between each capillary has a thickness of no more than the maximum width or diameter of the capillaries.

According to yet another embodiment of the present invention, there is provided a consumable product comprising an extruded body portion, the body portion having a plurality of capillaries disposed therein, the capillaries having a non-uniform cross section along their length, and having a width or diameter of less than about 0.2 mm.

According to yet another embodiment of the present invention, there is provided a consumable product comprising an extruded body portion, the body portion having a plurality of capillaries disposed therein, the capillaries in the body portion having a non-uniform cross section along their length, and resulting in a voidage in the range of about 5-99% of the extrudate.

The skilled addressee will of course realise that these subsequent embodiments may incorporate features which have already been discussed with reference to the initial embodiments.

As mentioned above, the invention provides a process for manufacturing a consumable product comprising a body portion, having a plurality of capillaries disposed therein, the process comprising the step of:
a) extruding an extrudable consumable material which is liquid during extrusion with a plurality of capillaries disposed therein, wherein the capillaries have a non-uniform cross section along their length.

In some embodiments, the process may include an extra step selected from:
b) cutting the extrudate into two or more pieces having a plurality of capillaries disposed therein and Rutting a consumable product incorporating the pieces; and/or
c) folding the extrudate and forming a consumable product incorporating the folded extrudate.

Any of the above processes may further comprise the step of depositing a filling in at least part of one or more of the capillaries. The deposition of the filling may be during the step of extrusion—but could also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the extrudate after extrusion. The quench cooling may utilise a fluid, such as air, an oil or liquid nitrogen—but other methods of quench cooling will also be apparent to the skilled addressee.

Any of the processes may further comprise the step of, immediately after extrusion, stretching or rotating the extrudate. Stretching or rotating the extrudate may be undertaken by a number of means, for example passing the extrudate over, or through conveyor belts or rollers operating at different speeds, so as to stretch the extrudate. By employing this additional step, extrusions having capillaries of a larger diameter can be undertaken, which can be reduced in diameter gradually over time so as to produce an extrudate with smaller capillaries which would have been more difficult to produce. Commonly, capillaries having a bore size of about 2 mm or more will be produced during extrusion and these capillaries will be reduced significantly by stretching the extrudate. In some embodiments the capillaries are reduced to no more than about 1 mm, 0.5 mm, 0.25 mm, 100 μm, 50 μm, 25 μm or 10 μm.

Any of the processes may further comprise the step of enveloping the consumable product in a coating. Such a coating will be apparent to the skilled addressee and was discussed previously hereinabove.

The extrudable consumable material will at least partially or substantially solidify after extrusion.

If desired, two or more capillaries may be formed having different maximum widths or diameters. Furthermore, two or more of the capillaries may be formed having different cross-sectional profiles.

The processes may be used for producing a consumable product as herein above described.

As mentioned above, the invention also provides apparatus which is adapted for producing a consumable product according to the processes as herein above described. WO 2005/056272 discloses an apparatus for producing an extrudated product including a plurality of capillary channels. WO 2008/044122 discloses a related apparatus, which additionally includes means for quench cooling an extrudate as it exits the die. Both of these apparatus may be employed/adapted for use in producing the consumable product in accordance with the present invention.

### DETAILED DESCRIPTION OF THE INVENTION AND EXAMPLES

Specific examples of the present invention will now be described, by way of illustration only, with reference to the accompanying drawings, in which:

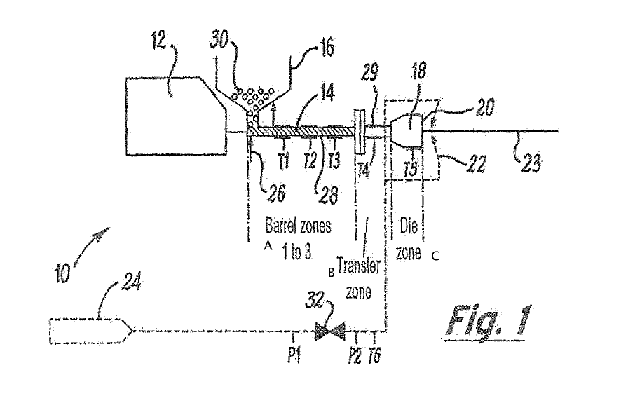

FIG. 1 is a schematic diagram illustrating the overall apparatus used in accordance with the present invention;

FIG. 2 is a schematic diagram illustrating the apparatus which can be used in conjunction with the apparatus shown in FIG. 1, so as to provide liquid filled capillaries;

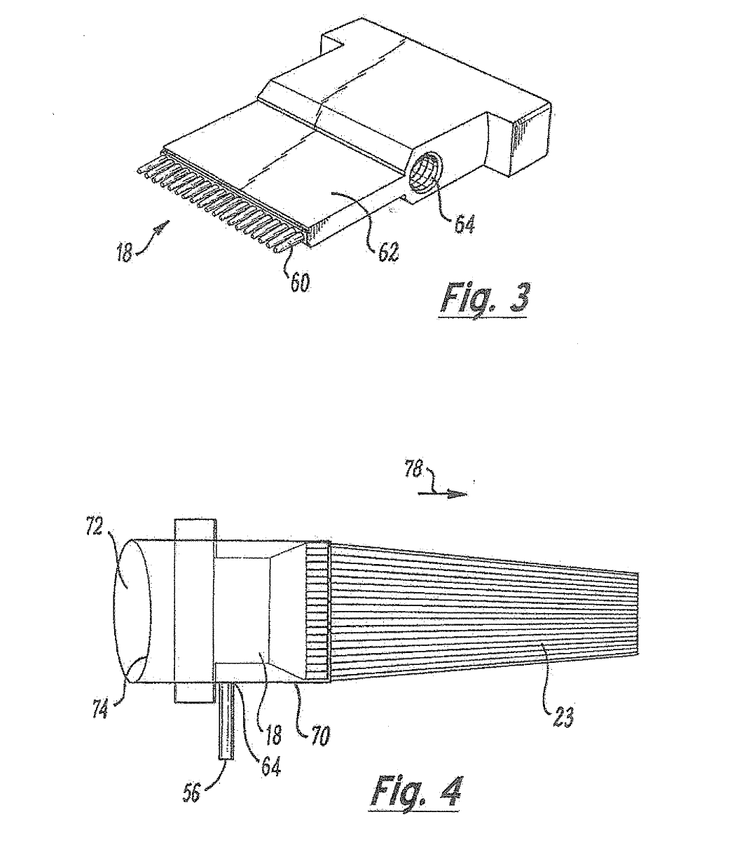

FIG. 3 is a photograph of the extrusion die used to form capillaries in the extruded material of the Example;

FIG. 4 is a plan view of the extrusion die which incorporates the extrusion die shown in FIG. 3 in the apparatus as illustrated in FIGS. 1 and 2;

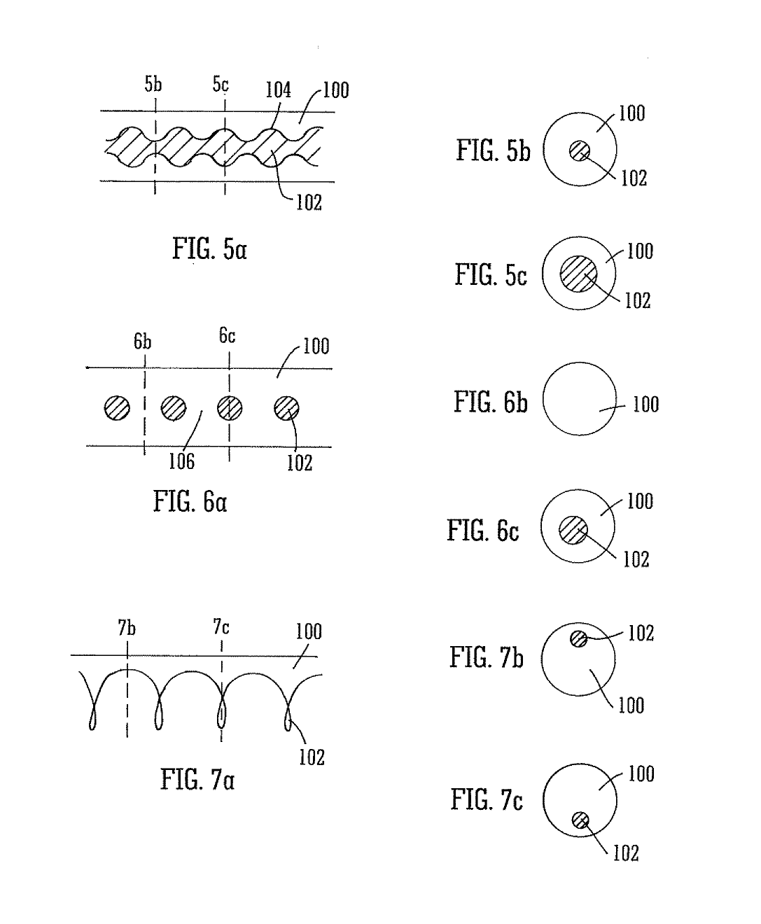

FIG. 5a is a side view of extruded material containing a single capillary whose width increases and decreases along the length of the product, and FIGS. 5b and 5c show cross sections of the material of FIG. 5a at points 5b and 5c (as labelled in FIG. 5a);

FIG. 6a is a side view of extruded material containing spherical capillaries, and FIGS. 6b and 6c show cross sections of the material of FIG. 6a at points 6b and 6c (as labelled in FIG. 6a);

FIG. 7a is a side view of extruded material containing a single helical capillary, and FIGS. 7b and 7c show cross sections of the material of FIG. 7a at points 7b and 7c (as labelled in FIG. 7a);

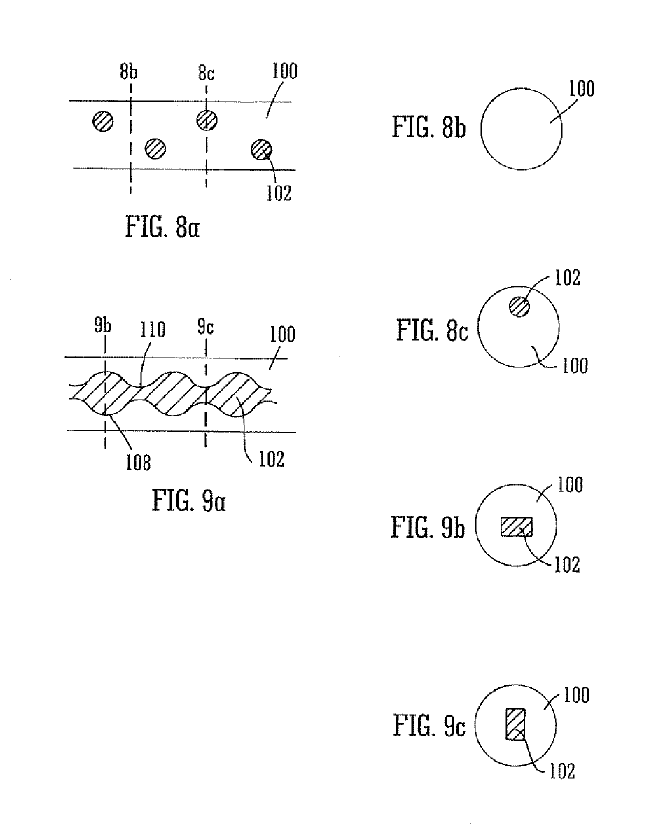

FIG. 8a is a side view of extruded material containing spherical capillaries, and FIGS. 8b and 8c show cross sections of the material of FIG. 8a at points 8b and 8c (as labelled in FIG. 8a);

FIG. 9a is a side view of extruded material containing a single capillary which has a rectantularly shaped cross-section and the capillary is rotated during extrusion, and FIGS. 9b and 9c show cross sections of the material of FIG. 9a at points 9b and 9c (as labelled in FIG. 9a);

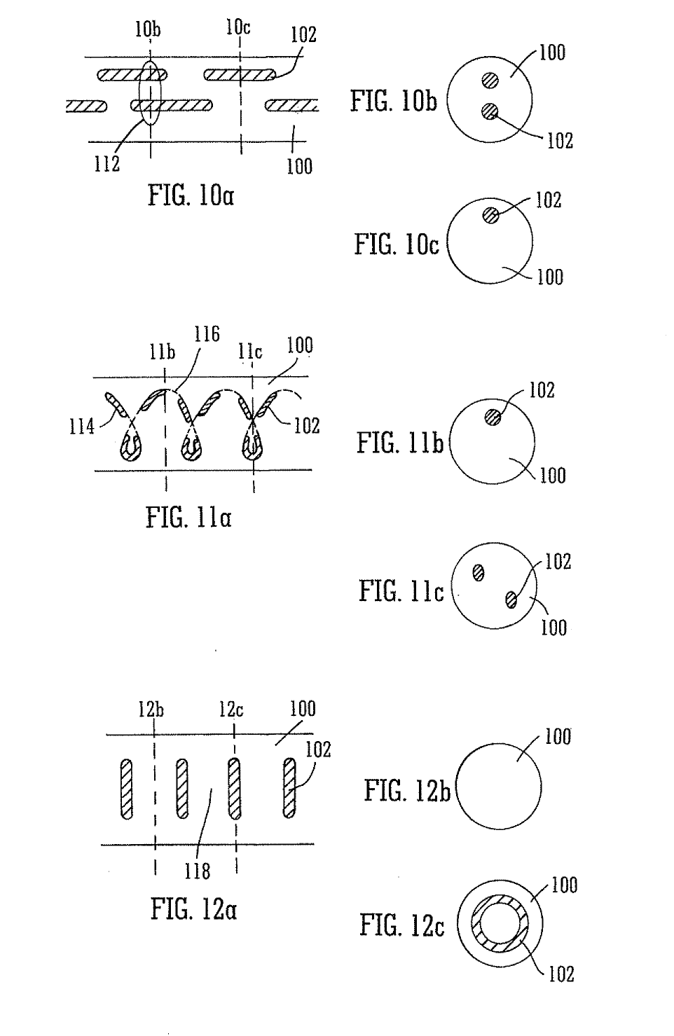

FIG. 10a is a side view of extruded material containing baguette shaped capillaries, and FIGS. 10b and 10c show cross sections of the material of FIG. 10a at points 10b and 10c (as labelled in FIG. 10a);

FIG. 11a is a side view of extruded material containing capillaries which extend part way along a helical path, and FIGS. 11b and 11c show cross sections of the material of FIG. 11a at points 11b and 11c (as labelled in FIG. 11a);

FIG. 12a is a side view of extruded material containing ring-shaped capillaries, and FIGS. 12b and 12c show cross sections of the material of FIG. 12a at points 12b and 12c (as labelled in FIG. 12a);

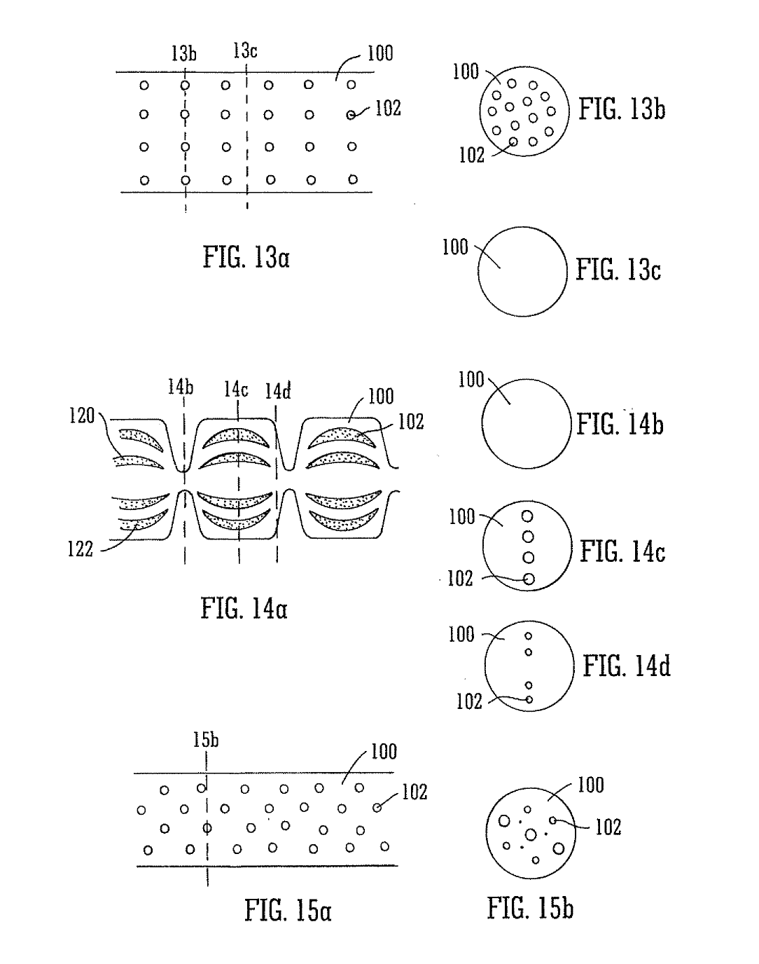

FIG. 13a is a side view of extruded material containing a plurality of spherically shaped capillaries, and FIGS. 13b and 13c show cross sections of the material of FIG. 13a at points 13b and 13c (as labelled in FIG. 13a);

FIG. 14a is a side view of extruded material containing a plurality of capillaries which have been separated by twisting or nipping the extrudate along its length, and FIGS. 14b-d show cross sections of the material of FIG. 14a at points 14b-d (as labelled in FIG. 14a); and

FIG. 15a is a side view of extruded material containing a plurality of pherically shaped capillaries, and FIG. 15b shows a cross section of the material of FIG. 15a at point 15b (as labelled in FIG. 15a).

Experiments were conducted to produce a variety of consumable products incorporating capillaries. Two phases of extrusion work were undertaken using various materials. The first phase concerned the extrusion of hard candy using a capillary die attached to a small-scale extruder in a non-food grade environment for creating capillary candy extrudates in both low- and high-voidage forms. The second phase of the experimental work built upon the first phase to produce low and high voidage candy capillary extrudates containing an array of cocoa-butter filled capillaries. The first and second phases are described in the below Example.

Phase one concerned the extrusion of candy using a capillary die attached to a small-scale extruder, in order to confirm that candy having capillaries exhibiting a non-uniform cross section along their length, and having both low and high voidage values, could be formed in accordance with the present invention.

The materials that were trialled during this investigation are shown in Table 1.

TABLE 1
Materials tested.

| Material | Material | | |
|---|---|---|---|
| number | name | Majority ingredients | Application |
| 1 | Custom | Sugar (40%) Glucose | Extruded |
| | recipe 1 | Syrup (60%) | matrix |
| 2 | Custom | Maltitol syrup (96%) Gum | Extruded |
| | recipe 2 | Arabic (2%) Water (2%) | matrix |
| 3 | Cocoa | Cocoa butter (100%) | Capillary |
| | butter | | filler |

Materials 1 and 2 were supplied as large solid blocks. All materials were crushed prior to extrusion to yield a fine granular powder, with grain sizes ranging between 1 mm and 5 mm, Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as candy in solution) which can be heated so as to render it (or maintain it as) a liquid (not solid or solid particulate form). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature is adjusted again (if required) by temperature control T4 before entering the die 18. The die 18 has a number of needles (not shown) located within an entrainment body so that the material passes over and around the needles. At the same time that the material is being extruded, compressed air 24 is forced through the needles so that the extrudate contains a number of capillaries. The air can be pulsed on and off to make capillaries which actually comprise a line of discrete bubbles, or the air pressure can simply be altered to give rise to continuous capillaries having a varying cross-sectional area along their length, from having a relatively wide diameter (for example, almost as wide as the body portion of the product itself) to extremely narrow (for example, on the micrometer scale). Similar effects can be achieved by rotating the die(s) and/or the extrudate to ‘nip’ the capillaries and thus produce ‘bubbles’, and by adjusting the rate of flow of the extrudate. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired. The rate of flow of cocoa butter is adjusted with time to give rise to varying cross-sectional areas of the capillaries with length. If a line of discrete bubbles is required, the flow of cocoa butter is pulsated on and off. Again similar effects can be achieved by rotating the die(s) and/or the extrudate to ‘nip’ the capillaries and produce bubbles, and by adjusting the rate of flow of the extrudate.

FIG. 3 shows a die 18 in more detail. In particular, this figure shows that the metallic die 18 has, at one end, a plurality of needles 60 which are joined to a cavity 62 which is in fluid communication with an inlet channel 64 for pumping a fluid material into the capillaries of the extrusion.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has capillaries with no filling or capillaries filled with cocoa butter. These capillaries have varying cross-sectional area along their length (not shown), which is achieved by adjusting flow rates and/or use of rotation as discussed above.

The manner in which cross section can vary with capillary length is shown schematically in the consumable products depicted in FIGS. 5-15. These consumable products were made using extruded gum with a fondant filling, and using the apparatus described above and depicted in FIGS. 1 and 2. All extruded body portions are substantially circular in cross section, but of course other shapes are also envisaged. The various capillary shapes were created by simple variation of dies and/or flow rate of fondant as is described in more detail with regard to each Figure and the same reference numeral is used to denote the same/similar features which are common to each embodiment.

Looking first at FIGS. 5a-c, these show a sinusoidal variation (104) in capillary cross-sectional area with capillary length, wherein FIG. 5a is a side view of a body portion 100 containing a capillary 102, and FIGS. 5b and 5c are cross sections of the body portion 100 and capillary 102 taken at the points 5b and 5c as shown in FIG. 5a. As is illustrated, the cross-sectional diameter of the capillary 102 in FIG. 5b is somewhat narrower than that in FIG. 5c. FIGS. 6a-6c show similar side views and cross sections of a body portion 100 and a capillary 102, wherein the variation in cross section of the capillary 102 oscillates such that the cross section of the capillary is at some points so narrow as to be negligible, (and hence not visible) (see reference numeral 106 and FIG. 6b). As a result the capillary 102 is effectively present as discrete bubbles. The capillaries of FIGS. 5 and 6 are formed by adjusting flow rates of extrudate and/or capillary fill material, although the arrangement of FIG. 6 can also be achieved by use of a circular nozzle that is centrally located in the extrudate of the body portion 100, and twisting the extrudate or the die to ‘nip’ the capillary 102.

FIGS. 7a-c and 8a-c show a capillary 102 within a body portion 100, wherein the capillary 102 is formed by rotating the extrudate and/or the die head, wherein the nozzle is circular but not centrally located in the extrudate. In FIGS. 7a-c the rotation is slow and continuous, resulting in a ‘loop’, or helical-shaped capillary 102 as shown, and in FIG. 8 it is discrete, and when it occurs it is fast enough to ‘nip’ the capillary 102 into bubbles. As an alternative to FIGS. 7a-c, the diameter of the capillary 102 can be non-uniform along its length as well as being in a helical configuration.

FIGS. 9a-c show a further variation in capillary 102 shape with length, similar to that shown in FIGS. 5a-c, this time the variation is formed by rotation of the extrudate/die, wherein the centre-fill nozzle within the die is rectangular and centrally located in the extrudate. When viewed from the side as in FIG. 9a, the capillary 102 oscillates between wide portions 108 and narrow portions 110, but the cross sectional area remains constant at all points.

FIGS. 10a-c show a further variation in shape with length where larger, more elongate, bubbles are formed as the capillaries 102 which are in the shape of a “baguette” and are in an alternating vertical stacking arrangement within the body portion 100. There are two lines of elongate bubbles arranged substantially parallel to each other such that there is always a vertical overlap 112 so at least one of the bubbles is visible in any cross-sectional view of the body portion 100, sometimes two, as shown in FIGS. 10b and 10c.

FIGS. 11a-c show a further variation in shape with length, similar to that shown in FIGS. 7a-c, which is also formed by rotation of the extrudate/die. However, rather than a complete helical turn, the capillaries only follow the path of part of the helix. It can be seen that the diameter of the capillary 102 is non-uniform along its length, ranging from relatively wide 114 to rather narrow 116 as formed by ensuring the fluid expulsion from the nozzle is sufficiently rapid and/or discrete to ‘nip’ the capillary 102 so that it becomes sufficiently narrow in parts of the body portion 100.

FIGS. 12a-c show a further variation in shape with length which is similar to those in FIGS. 6a-6c except that rather than bubbles, the capillaries are in the shape of a ring which are elongate in a vertical direction when viewed from a side perspective as shown in FIG. 12a. Again, as in FIGS. 6a-6c, the section of capillary 102 connecting the broader cross-section parts is so narrow as to be negligible 118, so as to cause the capillary 102 to be effectively present as discrete bubbles. When the cross-section of the body portion 100 is viewed down its length as shown in FIGS. 12b and 12c, it can be seen that the bubbles are substantially discrete, and also that they are circular in shape, extending all around the circular-shaped body portion 100. This shape can be achieved by use of a circular die that is rotated about a point to provide the centre-fill in such a pattern, or by use of a capillary die that has a body portion die within it.

FIGS. 13a-c show a further variation in shape with length which comprises a number of bubbles (capillaries 102) arranged in lines both horizontally and vertically in the extrudate 100. It can be seen that in FIG. 13b an ordered pattern of bubbles exists whilst the cross-section of FIG. 13a shows no bubbles. As with the embodiment in FIGS. 6a-c, this arrangement can be achieved by use of an array of circular nozzles that are centrally located in the die head.

FIGS. 14a-d show a further variation in shape with length which comprises capillaries 102 in the form of a number of arc-shaped capillaries arranged in a pattern with two such bubbles located at the top of the body portion 100 and oriented with the arcs pointing downwards 120, and with the other two such capillaries located at the lower part of the body portion 100 and oriented with the arcs pointing upwards 122. In this embodiment, the body portion 100 is shown as being segmented with the segmentation being located either side of the arced bubbles. It can be seen that the arced capillaries themselves are of non-uniform width, so the cross-sectional view of FIG. 14c shows capillaries having a larger diameter than the bubbles revealed by the cross-sectional view of FIG. 14d. This arrangement can be made by using four nozzles with variable flow rates of extrudate/capillary fill material, and the body portion 100 being rotated or nipped at the position indicated at 14b as the flow rate is decreased or stopped temporarily.

FIGS. 15a and b show a further variation in shape with length which comprises a number of bubbles arranged in a random orientation within the body portion 100. As the arrangement is random, in any cross-sectional view there are likely to be some bubbles of capillary 102 visible, as shown in FIG. 15b. This arrangement can be achieved by employing variable flow rates of the capillary material during extrusion.

It will be appreciated that whilst all of the above examples were made using gum with a fondant filling, the body portion 100 may of course be any of candy, chocolate or gum-based consumable products and the capillary 102 may be any liquid or gas.

Although the body portion and capillaries may be depicted as uniform in shape and pattern in some embodiments described herein, it should be understood that the body portion and/or the capillaries may be non-uniform in some embodiments. There may be variations in the overall dimensions of the product, such as, for instance, the dimensions of the body portion, the capillaries, the wall thicknesses between each capillary and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the capillaries. The capillaries accordingly may be irregularly positioned in some embodiments. In addition, the capillaries may be symmetrically disposed in the body portion or asymmetrically disposed in the body portion. In some embodiments, one group of capillaries may be symmetrically disposed and another group of capillaries may be asymmetrically disposed in the body portion.

The foregoing embodiments are not intended to limit the scope of protection afforded by the claims, but rather to describe examples as to how the invention may be put into practice.

1. A consumable product comprising an extruded body portion, the body portion being formed with a plurality of capillaries disposed therein, wherein the capillaries have a non-uniform cross section along their length.

2. A consumable product as claimed in claim 1, wherein the cross section is non-uniform in area and/or shape.

3. A consumable product as claimed in claim 1 or claim 2, wherein the plurality of capillaries are arranged in a substantially linear arrangement throughout the body portion.

4. A consumable product as claimed in claim 3, wherein the body portion comprises a plurality of lines of capillaries.

5. A consumable product as claimed in claim 4, wherein the lines of capillaries are in a staggered configuration throughout the body portion.

6. A consumable product as claimed in claim 5, wherein the lines of capillaries overlap in a staggered configuration.

7. A consumable product as claimed in any of claim 1 or claim 2, wherein the plurality of capillaries are arranged in a substantially non-linear arrangement throughout the body portion.

8. A consumable product as claimed in any preceding claim, wherein the body portion is extruded along a longitudinal axis and at least one capillary is formed along and/or around at least part of the longitudinal axis of the body portion.

9. A consumable product as claimed in any preceding claim, wherein the maximum cross-sectional area of the capillary is at least 10% greater than the minimum cross-sectional area.

10. A consumable product as claimed in any preceding claim, wherein at least one capillary is substantially spherical, elongated, looped, arc-shaped or at least partially helical in shape.

11. A consumable product as claimed in any preceding claim, wherein at least one capillary is filled with a fluid material.

12. A consumable product as claimed in claim 11, wherein the fluid comprises a liquid.

13. A consumable product as claimed in any preceding claim, wherein at least one capillary is filled with a liquid material which solidifies.

14. A consumable product as claimed in any preceding claim, wherein the body portion is formed from a material which is liquid during extrusion.

15. A consumable product as claimed in any preceding claim where the body portion comprises a first extruded portion and a second extruded portion, wherein each portion has a plurality of capillaries disposed therein, and the capillaries of the first and second portions are:
a) discontinuous; and/or
b) continuous and oriented in more than one direction.

16. A consumable product as claimed in any preceding claim, wherein the product is confectionery.

17. A consumable product as claimed in claim 16, wherein body portion comprises gum, candy or chocolate.

18. A process for manufacturing a consumable product comprising a body portion having a plurality of capillaries disposed therein, the process comprising the step of:
extruding a material with a plurality of capillaries disposed therein, wherein the capillaries have a non-uniform cross section along their length.

19. A process as claimed in claim 18, wherein the non-uniform cross section is achieved by varying the rate of extrusion of the body portion relative to the rate of capillary formation and/or by varying the orientation or position of the capillary within the body portion during extrusion.

20. A process as claimed in claim 18, wherein the non-uniform cross-section is achieved by stretching, compacting or rotating the body portion during and/or after extrusion.

21. A process as claimed in any one of claims 18 to 20, wherein the process further comprises the step of depositing a filling in at least part of one or more of the capillaries.

22. A process as claimed in claims 21, wherein the filling is deposited during the step of extrusion.

23. A process as claimed in any one of claims 18 to 22, wherein the material being extruded is liquid during extrusion.

24. An apparatus adapted for producing a consumable product according to the process claimed in any one of claims 18 to 22.

25. A consumable product substantially as described herein and with reference to the accompanying drawings.

26. A process for producing a consumable product substantially as described herein and with reference to the accompanying drawings.
